(19) United States
(12) Patent Application Publication
(10) Pub. No.: US 2006/0082771 A1
(43) Pub. Date: Apr. 20, 2006

(54) Mount of optical components

(75) Inventors: Rolf Doerrmann, Karlsruhe (DE); Karsten Kraiczek, Waldbronn (DE); Jochen Mueller, Karlsruhe (DE)

Correspondence Address: Paul D. Greeley, Esq.;Ohlandt, Greeley, Ruggiero & Perle, L.L.P., 10th Floor, One Landmark Square, Stamford, CT, 06901-2682, US

(73) Assignee: Agilent Technologies, Inc.

(21) Appl. No.: 10/964,992

(22) Filed: Oct. 14, 2004

(51) Int. Cl. G01J 3/28

(52) U.S. Cl. 356/328

(57) ABSTRACT

A casing for an optical set-up is described, with the casing comprising a cutout adapted for accommodating an optical component, wherein the geometry of the cutout is adapted for mounting the optical component from the exterior of the casing, and wherein the geometry of the cutout is adapted for mechanically fastening the optical component by means of an elastic force exerted radially upon the outer surface of the optical component.

### BACKGROUND ART

The present invention relates to the casing for an optical set-up, to a spectrophotometer, and to a method for mounting an optical component in a cutout of a casing.

U.S. Pat. No. 4,805,993 “Method of Assembling Optical Components and Arrangement Therefor” to M. Blumentritt et al. describes a method for assembling an optical component in a frame. The optical component is connected to the frame only by means of an adjusting device. The method includes the steps of providing a part disposed between the optical component and the frame, applying a self-hardening substance to the interface of the part and the frame, thereby establishing a permanent first fixation, and applying a self-hardening substance to the interface of the part and the optical component, thereby establishing a permanent second fixation independent of the first fixation. The part is configured and dimensioned so as to provide optimal volume and layer thicknesses for the substance.

U.S. Pat. No. 5,615,010 “Diode Array Spectrophotometer” of K. Kraiczek et al. describes a diode array spectrophotometer having an entrance slit apparatus, a diffraction grating, a diode array and a casing to define the relative positions of these elements. The casing and the holder for accepting the diffraction grating a made of a ceramic whose coefficient of thermal expansion is adapted to that of the diode array. The grating holder has a cylindrical outer surface and is situated within a conic-frustum-shaped opening of the casing. Between the grating holder and the conic-frustum-shaped opening, there are pluralities of filler elements, which are made of ceramic or glass.

### DISCLOSURE OF THE INVENTION

It is an object of the invention to provide an improved optical mount. The object is solved by the independent claim(s). Preferred embodiments are shown by the dependent claim(s).

According to embodiments of the present invention, a casing for an optical set-up comprises a cutout adapted for accommodating an optical component, wherein the geometry of the cutout is adapted for mounting the optical component from the exterior of the casing, and wherein the geometry of the cutout is adapted for mechanically fastening the optical component by means of an elastic force exerted radially upon the outer surface of the optical component.

The optical component is inserted into the casing's cutout from the exterior, and it is fixed by means of elastic forces that act upon the outer surface of the optical component. Hence, the optical component is held at a fixed spatial position; no tilt is possible. An optical mount according to embodiments of this invention does not require the use of any adhesive. For this reason, problems due to thermal and moisture sensitivity of the adhesive are completely avoided. There is no adhesive gap between the optical component and the housing, and the mechanical stability is improved.

Another advantage of the optical mount is that the optical component may be exchanged whenever this is necessary. Furthermore, the optical mount can be realized at low cost. The requirements on the precision of the optical component's outer diameter are kept rather low, allowed fit tolerances are rather large, and accordingly, the optical component can be manufactured at low cost. Furthermore, the thermal expansion coefficient of the casing may differ from the thermal expansion coefficient of the optical component. Any suitable material may be used for the casing, and hence, the cost for the casing may be reduced.

According to a preferred embodiment, the casing is made of metal, preferably of aluminum. An aluminum casing can be manufactured with high accuracy.

In another preferred embodiment, the optical component is a lens, a mirror or a diffraction grating. Further preferably, the optical component is made of glass or ceramics. Even if large forces act upon an optical component made of ceramics, no significant deformation will be observed. Furthermore, the thermal expansion coefficient of ceramics is rather low. For these reasons, ceramics are well suited as a material for manufacturing diffraction gratings.

In a preferred embodiment, both the optical component and the corresponding cutout in the casing are cylindrically shaped. A cylindrically shaped outer contour can be manufactured with high accuracy. Furthermore, an equal distribution of the elastic forces that are used for fastening the optical component is accomplished.

According to a preferred embodiment, both the fit tolerances of the optical component's outer contour as well as the fit tolerances of the cutout's inner contour are chosen such that a tight press fit is achieved. In this embodiment, the elastic force for fixing the optical component is due to an elastic deformation of the casing itself. By means of a press fit, the optical component can be invariably fixed with excellent mechanical stability, whereby the precision of the mount might e.g. be in the low sub-micron range. The lack of any adhesive layer further improves the mechanical stability of the optical set-up.

The fit tolerances of the cutout's inner contour as well as the fit tolerances of the optical component's outer contour can be chosen such that, within a desired range of temperatures, the reliability of the press fit is guaranteed. For example, the fit tolerances may be chosen such that between 40° C. and 70° C., the optical compound is invariably fixed in the cutout. Even if the coefficients of thermal expansion of the optical compound and of the casing differ considerably, a tight press fit may be accomplished within the entire range of temperatures. This feature is often referred to as “reliability of operation”.

According to a preferred embodiment, the press fit is produced using a shrinking-on technique, further preferably by means of heat shrinking. There exist different possibilities for heat shrinking the casing's cutout onto the outer contour of the optical component. According to a first possibility, the casing is heated up, e.g. to a temperature between 100-200° C., before the optical component, which has not been heated up, is inserted into the cutout. Then, the casing is slowly cooled down to room temperature, and a tight press fit between the casing and the optical component is produced. According to a second possibility, the casing is kept at room temperature, whereas the optical component is cooled down before it is inserted into the corresponding cutout. For example, liquid nitrogen might be used for cooling down the optical component. Then, the optical component is slowly brought to room temperature.

In a preferred embodiment, the cutout comprises a recess that defines the position of the optical component. When inserting the optical component into the cutout, the recess might act as a stopper.

According to an alternatively preferred embodiment, a spring element is placed in a circumferential gap between the optical component and the casing. The spring element is adapted for exerting an elastic force upon the optical component's outer surface, and for mechanically fixing the optical component. Also in this embodiment, no adhesive is required for fixing the optical component. The spring element can be realized in a way that good mechanical stability is achieved in a temperature range that might e.g. extend from −40° C. to 70° C. If an optical component is fastened by a spring element, it will be possible to replace this optical component whenever this will become necessary. In this embodiment, the requirements imposed upon the precision of the optical component's outer diameter are rather low, and hence, an optical mount using a spring element can be realized at low cost.

In a preferred embodiment, the spring element comprises a multitude of spring segments. Thus, it is possible to adjust the shape of the spring element to some degree, in order to fit the spring element into the gap between the optical component and the casing.

According to a preferred embodiment, one or more of the spring segments comprise spring blades that are bent radially inwards. These spring segments are adapted for fixing the rear face of the optical component. Further preferably, these spring blades are slightly overbent in order to exert an axial force upon the rear face of the optical component. This axial force might e.g. be adapted for pressing the optical component against a recess of the cutout. Thus, the optical component can be fixed in a well-defined position.

According to yet another preferred embodiment, the spring element might comprise V-shaped spring blades that are bent radially outwards. When these V-shaped spring blades are compressed, they exert an inwards force upon the optical component's outer surface. The elastic forces exerted by the surrounding spring element tightly fix the optical component.

According to a further preferred embodiment, a cover plate adapted for covering the optical component is fixed to the cutout from the exterior of the casing. By covering the cutout, it is made sure that dirt, dust and other contaminations do not get into the interior of the optical apparatus. Furthermore, the cover plate might exert an additional pressure upon the V-shaped spring blades and enhance the radial forces acting upon the optical component.

A spectrophotometer according to the present invention comprises a casing with an entrance slit, and a diffraction grating, with the diffraction grating being mounted into a corresponding cutout of the casing. The spectrophotometer further comprises a photodiode array adapted for spectrally analyzing light diffracted by the diffraction grating. The adjustment of the path of the rays is performed by adjusting the position of the photodiode array, whereas the position of the diffraction grating is invariably fixed.

In solutions of the prior art, the adjustment of the light path has been performed by adjusting the position of the diffraction grating. In the spectrophotometer according to the present invention, the diffraction grating is placed in a corresponding cutout of the casing. It might be necessary to rotate the diffraction grating to its correct position, but then, no further adjustments of the position of the diffraction grating are performed. Hence, the mechanical and thermal stability of the set-up is improved. The fine adjustment of the light path is performed by adjusting the position of the photodiode array before said photodiode array is fixed.

According to a preferred embodiment, the optical component is mounted into the cutout from the exterior of the casing.

### BRIEF DESCRIPTION OF DRAWINGS

Other objects and many of the attendant advantages of embodiments of the present invention will be readily appreciated and become better understood by reference to the following more detailed description of preferred embodiments in connection with the accompanied drawing(s). Features that are substantially or functionally equal or similar will be referred to with the same reference sign(s).

FIG. 1 shows a first embodiment of the invention with an optical component being fastened by means of a press fit;

FIG. 2 shows a second embodiment, whereby a spring element is used for fixing an optical component;

FIG. 3 gives a more detailed view of the spring element;

FIG. 4 shows a cross-section through an optical mount according to the second embodiment; and

FIG. 5 shows the optical set-up of a photodiode array spectrophotometer.

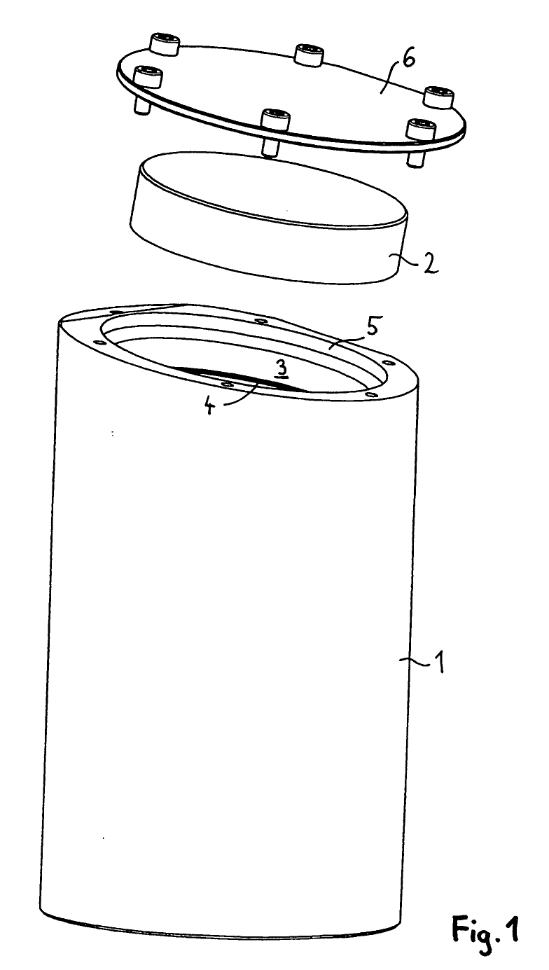

FIG. 1 shows a first embodiment of an optical mount, whereby the optical component is fastened by means of a press fit. A casing 1 of an optical apparatus comprises a cutout adapted for accommodating an optical component 2, which is inserted into the cutout from the exterior of the casing 1. The optical component 2 might e.g. be a mirror, a lens, or a diffraction grating. The optical component 2 might e.g. be made of glass or ceramics. Preferably, the housing of the optical apparatus is made of metal, e.g. of aluminum.

In order to accomplish a press fit, the inner contour of the cutout's portion 3 corresponds to the outer contour of the optical component 2, whereby the fit tolerances are chosen such that a tight fit is accomplished. The inner diameter of the cutout's portion 3 is slightly smaller than the outer diameter of the optical component 2, and hence, the casing's cutout can be heat shrunk onto the optical component 2. According to a first possibility, the metal casing is heated up before the optical component 2 is positioned in the cutout. For example, the metal casing might be heated up to a temperature of approximately 200° C. According to an alternative possibility, the optical component 2 is cooled down, e.g. by means of liquid nitrogen, before being placed into the casing's cutout.

There exist a variety of different standard definitions that define fit tolerances for a press fit, e.g. the standard DIN 7155 T1. Generally, an outer contour can be manufactured with higher accuracy than an inner contour. For example, the optical component 2 might have a diameter of 54 mm± 1/1000, which corresponds to a fit tolerance of ±1 μm. For a thermal press fit, the corresponding inner diameter of the cutout has to be slightly smaller than 54 mm. The standard DIN 7155 T1 defines a fit tolerance p7 ranging from − 21/1000 to − 51/1000, and a fit tolerance p8 ranging from − 32/1000 to − 78/1000. The fit tolerances p7 and p8 provide a good trade-off between accuracy on the one hand and manufacturing cost on the other hand.

The cutout shown in FIG. 1 further comprises a recess 4 for defining the position of the optical component 2. After the casing 1 has been heated up or the optical component 2 has been cooled down, the optical component 2 is inserted into the cutout in a way that it sits on the recess 4. Then, both the casing and the optical component are brought back to room temperature, and a press fit is accomplished. The optical component 2 can e.g. be mounted by means of a collet chuck or a vacuum suction device. The cutout of the casing 1 might further comprise a portion 5 with a large inner diameter, in order to provide extra headspace for the collet chuck. For protecting the optical component 2 from dust, dirt and other contamination, a cover plate 6 might finally be screwed onto the cutout of the casing 1.

After the optical component has been mounted into the casing 1 using a shrinking-on technique, the casing 1 exerts a force directed radially inwards upon the outer surface of the optical component 2. The optical component 2 is securely fastened by this elastic force, and no adhesive layer is required.

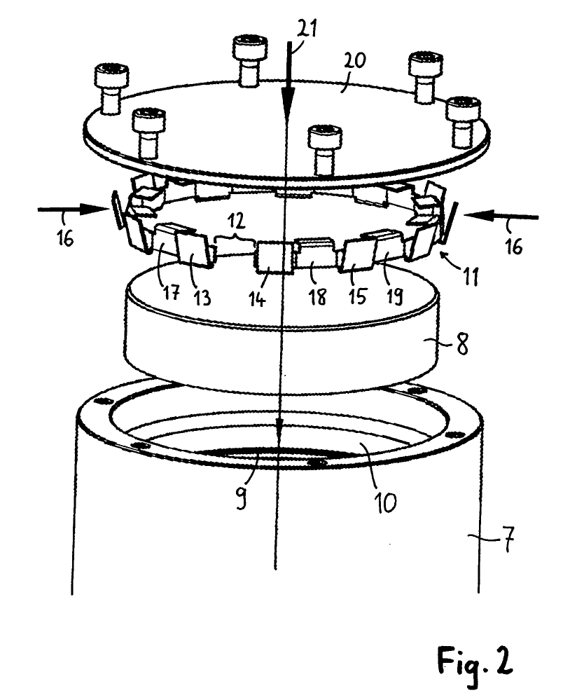

Instead of the casing itself exerting an elastic force upon the optical element, a spring element might be placed in the gap between the optical component and the cutout of the casing, with the spring element being adapted for fastening the optical component. FIG. 2 shows a second embodiment of the invention with a spring element. A casing 7 of an optical apparatus comprises a cutout adapted for accommodating an optical component 8, which is inserted into the cutout from the exterior. The cutout comprises a recess 9 that acts as a stopper and defines the position of the optical component 8. The inner diameter of the portion 10 corresponds to the outer diameter of the optical component 8 in a way that a loose fit is accomplished. The portion 10 of the cutout is adapted for laterally positioning the optical component 8.

A spring element 11 is placed in the circumferential gap between the casing 7 and the optical component 8. The spring element 11 is realized as a C-shaped spring element, which means that there is an opening 12 between the first spring segment 13 and the last spring segment 14. Thus, the spring element's circumference can be adjusted to the optical element 8. The spring element 11 comprises two different types of spring segments. The spring segments 13, 14, 15 each comprise a V-shaped spring blade that is bent outwards. When deforming these V-shaped spring blades, an elastic force 16 is generated, which is directed radially inwards onto the outer surface of the optical component 8. The spring element 11 further comprises spring segments 17, 18, 19 of a second type, each of which comprises a spring blade that is bent inwards. Preferably, the spring blades of the second type are overbent. The spring blades of the second type of spring segments 17, 18, 19 exert an axial force 21 upon the rear face of the optical component 8. As a consequence, the optical component 8 is tightly pressed towards the recess 9 of the cutout.

By introducing a spring element 11 in the gap between the optical component 8 and the casing 7, both a radial force 16 and an axial force 21 are exerted upon the optical component 8. Thus, the optical component 8 is tightly fixed in the desired position without using any kind of adhesive.

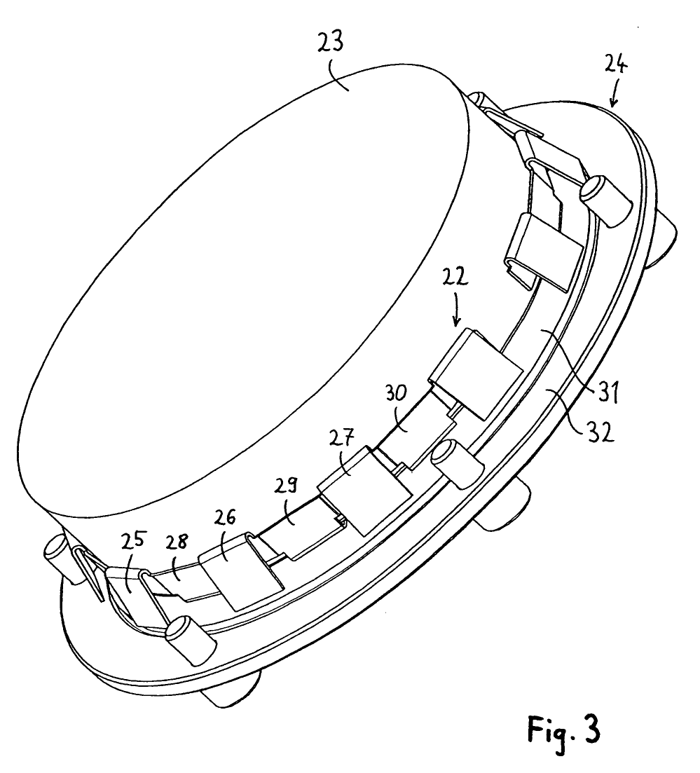

FIG. 3 gives a more detailed view of a spring element 22, of an optical component 23, and of a cover plate 24. It can be seen that the spring element 22 comprises spring segments 25, 26, 27 of the first type as well as spring segments 28, 29, 30 of the second type. The spring blades of the first type of spring segments 25, 26, 27 are bent outwards and exert forces directed radially inwards, whereas the spring blades of the second type of spring segments 28, 29, 30 are bent inwards and exert an axial force upon the rear face of the optical component 23. The cover plate 24 comprises a center section 31 and an outer rim 32, whereby the thickness of the outer rim 32 is reduced relative to the thickness of the center section 31. When the cover plate 24 is screwed onto the casing, the cover plate's center section 31 deforms the spring blades of the spring segments 25, 26, 27 of the first type, and each of these segments exerts a radial force upon the outer surface of the optical component 23.

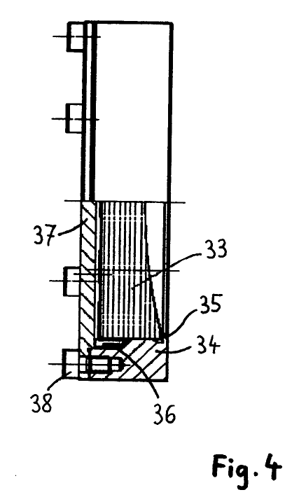

FIG. 4 shows a cross section of an optical mount according to the second embodiment of the invention. An optical component 33 is inserted in a cutout of a housing 34 and sits on a circumferential recess 35. A spring element 36 is placed in the gap between the optical component 33 and the housing 34. The spring element 36 comprises both spring blades that are bent inwards and spring blades that are bent outwards. In order to secure both the optical component 33 and the spring element 36, the cover plate 37 is attached to the housing 34 by means of several screws 38.

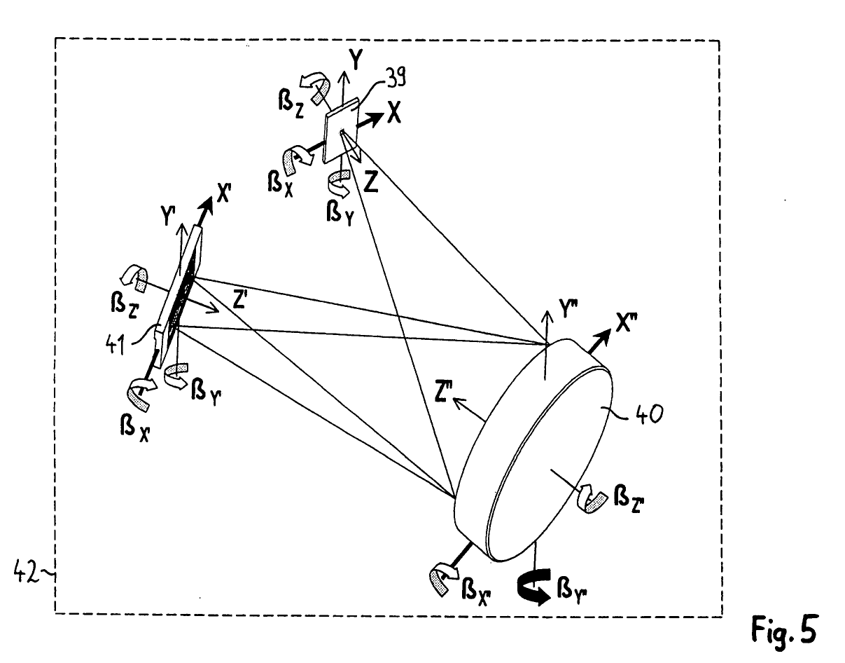

An optical mount according to the first or the second embodiment of the present invention can be employed in any optical apparatus comprising one or more optical components. As an example system, a set-up of a photodiode array spectrophotometer is shown in FIG. 5. The spectrophotometer comprises an entrance slit 39, a diffraction grating 40, a photodiode array 41 and a housing 42 adapted for defining the respective positions of the components. Incident light that passes through the entrance slit 39 is diffracted by the diffraction grating 40, and the diffracted light is spectrally analyzed by the photodiode array 41. To each of the components shown in FIG. 5, a separate coordinate system has been assigned. The coordinate system X, Y, Z is assigned to the entrance slit 39, the coordinate system X′, Y′, Z′ is related to the photodiode array 41, and the coordinate system X″, Y″, Z″ is centered at the diffraction grating 40.

In FIG. 5, those displacements and tilts that are most critical are indicated with fat arrows. In particular, all the components are rather sensitive to displacements in the X-, X′- and X″-direction, respectively. Furthermore, the diffraction grating 40 is sensitive to tilts around the Y″-axis, which are denoted by the arrow β_{Y″}.

The mechanical stability of the spectrophotometer set-up shown in FIG. 5 can be considerably improved by mounting the diffraction grating 40 according to one of the embodiments of the present invention. The diffraction grating 40 may be inserted into a corresponding cutout of the housing 42. For example, the diffraction grating 40 may be mounted into a tubular housing like the one shown in FIG. 1 or in FIG. 2. The diffraction grating 40 may be fixed by means of a shrinking-on technique according to the first embodiment of the invention. Alternatively, the diffraction grating 40 may be mechanically fastened using a spring element according to the second embodiment of the invention. In both embodiments, there is not adhesive gap between the diffraction grating 40 and the housing 42, and hence, any effect of thermal and moisture sensitivity of the adhesive is eliminated. In contrast to solutions of the prior art, the position of the diffraction grating 40 is invariably fixed. For this reason, any adjustment of the spectrophotometer's light path is performed by varying the position of the photodiode array 41 relative to the other components.

1. A casing for an optical set-up,
the casing comprising a cutout adapted for accommodating an optical component,
wherein the geometry of the cutout is adapted for mounting the optical component from the exterior of the casing, and
wherein the geometry of the cutout is adapted for mechanically fastening the optical component by means of an elastic force exerted radially upon the outer surface of the optical component.

2. The casing of claim 1, wherein the casing is a metal casing, in particular an aluminium casing.

3. The casing of claim 1, wherein the optical component is one of: a lens, a mirror, a diffraction grating.

4. The casing of claim 1, wherein the optical component is made of glass or ceramics.

5. The casing of claim 1, wherein the optical component is implemented as a flat cylindrical body with a cylindrical outer surface, and whereby the cutout is a cylindrically shaped cutout.

6. The casing of claim 1, wherein the fit tolerance of the cutout's inner dimensions and the fit tolerance of the optical component's outer dimensions are chosen such that a press fit is accomplished.

7. The casing of claim 1, wherein a press fit between the cutout of the casing and the optical component is established by means of a shrinking-on technique.

8. The casing of claim 1, wherein the cutout is provided with a recess adapted for defining the spatial position of the optical component.

9. The casing of claim 1, further comprising a spring element positioned in a circumferential gap between the cutout of the casing and the optical component, whereby the spring element is adapted for exerting an elastic force directed radially upon the outer surface of the optical component, in order to fasten the optical component.

10. The casing of claim 9, wherein the spring element is implemented as a multi-segment spring element.

11. The casing of claim 9, wherein at least one of the spring element's segments comprises spring blades that are overbent in an inwards direction.

12. The casing of claim 11, wherein the spring blades that are overbent in an inwards direction are adapted for pressing the rear face of the optical component axially towards a recess of the cutout.

13. The casing of claim 9, wherein at least one of the spring element's segments comprises V-shaped spring blades that are bent outwards.

14. The casing of claim 13, wherein the V-shaped spring blades are adapted for exerting an elastic force directed radially upon the outer surface of the optical component, in order to fasten the optical component.

15. The casing of claim 9, further comprising a cover plate adapted for being mounted onto the cutout from the exterior of the casing, the cover plate being adapted for securing both the spring element and the optical component.

16. A spectrophotometer comprising
a casing with an entrance slit;
a diffraction grating, the diffraction grating being mounted into a corresponding cutout of the casing;
a photodiode array adapted for spectrally analysing light diffracted by the diffraction grating;
wherein the adjustment of the path of the rays is performed by adjusting the position of the photodiode array, and wherein the position of the diffraction grating is invariably fixed.

17. The spectrophotometer of claim 16, wherein the geometry of the cutout is adapted for mounting the optical component from the exterior of the casing.

18. The spectrophotometer of claim 16, wherein the geometry of the cutout is adapted for mechanically fastening the optical component by means of an elastic force exerted radially upon the outer surface of the optical component.

19. The spectrophotometer of claim 16, wherein the diffraction grating is made of ceramics.

20. A method for mounting an optical component in a cutout of a casing, the method comprising a step of
mounting the optical component into the cutout from the exterior of the casing such that that the optical component is mechanically fastened by an elastic force exerted radially upon the outer surface of the optical component.

21. The method of claim 20, further comprising a step of positioning the optical component in the cutout by means of a collet chuck or by means of a vacuum suction device.

22. The method of claim 20, further comprising a step of heat shrinking the cutout of the casing onto the optical component.

23. The method of claim 20, further comprising a step of heating up the casing before mounting the optical component into the cutout of the casing.

24. The method of claim 20, further comprising a step of cooling down the optical component before mounting the optical component into the cutout of the casing.

25. The method of claim 20, further comprising a step of placing a spring element in a circumferential gap between the casing and the optical component.

26. The method of claim 20, further comprising a step of mounting a cover plate onto the cutout from the exterior of the casing.
